(19) United States
(12) Patent Application Publication
(10) Pub. No.: US 2012/0014497 A1
(43) Pub. Date: Jan. 19, 2012

(54) DOOR CYCLE TRACKER

(76) Inventor: Jeff Longyear, Port Byron, NY (US)

(21) Appl. No.: 12/835,992

(22) Filed: Jul. 14, 2010

(51) Int. Cl. G06M 7/00

(52) U.S. Cl. 377/6

(57) ABSTRACT

A door cycle tracker for a door with at least an open position and a closed position mounted on a track having at least one spring. The door cycle tracker includes a counter mounted to the door having an actuator for incrementing the counter; a trip lever pivotally mounted adjacent to the counter and moveable to a position in which the trip lever actuates the counter actuator; and a plate assembly mounted adjacent to the track in a location such that when the door approaches a selected position, the trip lever contacts the plate assembly. When the door slides on the track and the trip lever contacts the plate assembly, the trip lever pivots, contacts the counter actuator and increments the counter.

### BACKGROUND OF THE INVENTION

1. Field of the Invention

The invention pertains to the field of cycle trackers. More particularly, the invention pertains to a cycle tracker for a door.

2. Description of Related Art

Many residential homes and businesses use overhead doors. Springs are used to aid in opening and closing overhead doors. The springs are very tightly tensioned. Most springs used with overhead doors have a life of about 10,000 cycles or about 10 years of normal use, with each cycle being one opening and one closing of an overhead door. A breaking spring that is not properly contained may lash out and strike people and or damage property. Currently, there is no way track the life cycle of the spring so that the springs can be properly replaced prior to them breaking and possible injuring people and property.

3. SUMMARY OF THE INVENTION

A door cycle tracker for a door with at least an open position and a closed position mounted on a track having at least one spring. The door cycle tracker includes a counter mounted to the door having an actuator for incrementing the counter; a trip lever pivotally mounted adjacent to the counter and moveable to a position in which the trip lever actuates the counter actuator; and a plate assembly mounted adjacent to the track in a location such that when the door approaches a selected position, the trip lever contacts the plate assembly. When the door slides on the track and the trip lever contacts the plate assembly, the trip lever pivots, contacts the counter actuator and increments the counter.

### BRIEF DESCRIPTION OF THE DRAWING

FIG. 1 shows a section of an interior elevation of a sectional overhead door in a closed position.

FIG. 2 shows a side view of the interior of a sectional overhead door in a closed position.

FIG. 3 shows a schematic of the cycle tracker.

FIG. 4 shows a side view of the interior of a sectional overhead door in an open position.

FIG. 5 shows a detailed view of a portion of FIG. 4.

### DETAILED DESCRIPTION OF THE INVENTION

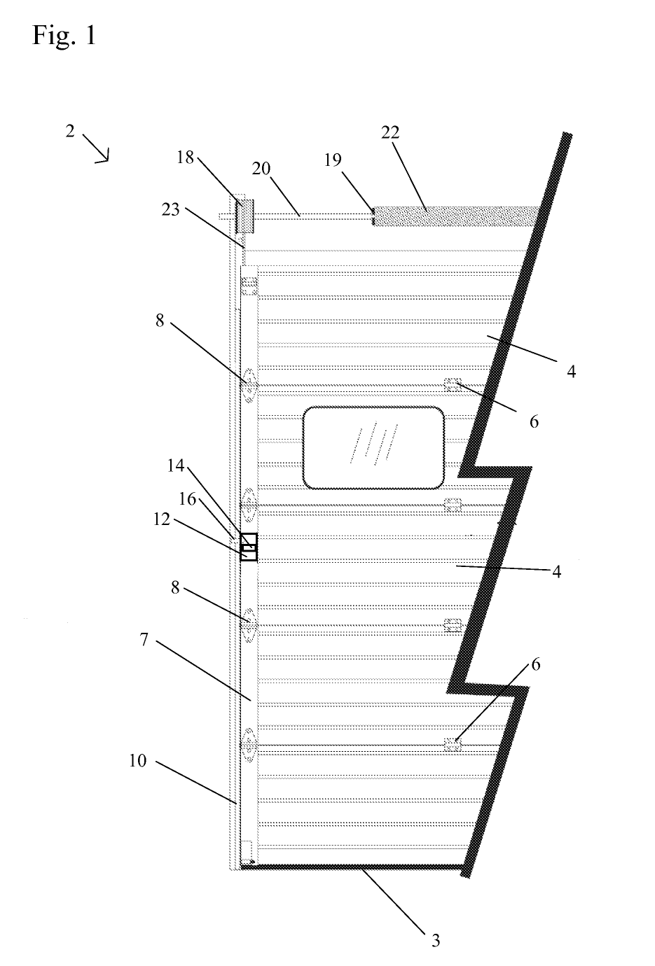

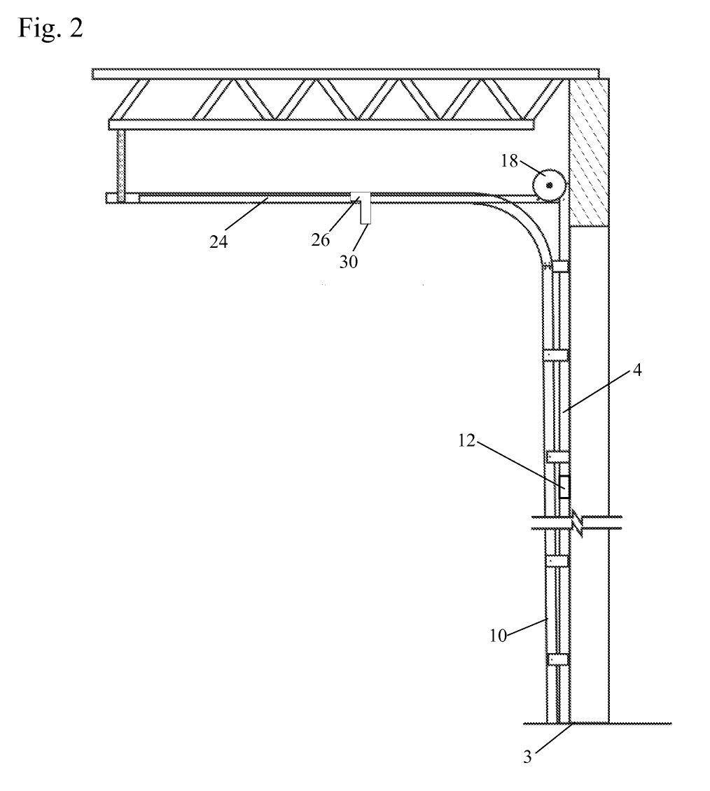

FIGS. 1-2 show an overhead door 2 in the closed position with a cycle tracker 12 of the present invention.

The overhead door 2 includes a series of sections 4 that are connected to each other by hinges 8 near the outer edge 7 of the door and another set of hinges 6 between the sections 4 and the outer edges 7. It should be noted that only one set of hinges 8 on the outer edge 7 and one set of hinges 6 between the outer edges 7 are shown in FIG. 1. Additional hinges may be present.

The outer edges 7 of the sections 4 of the overhead door 2 are mounted on a vertical track 10. The vertical track 10 transitions into a horizontal track 24 as shown in FIG. 2. Attached to an outer edge 7 of one of the sections 4 of the overhead door is cycle tracker 12. The cycle tracker 12 tracks the number of door cycles which can be used to predict the life cycle of the spring. One cycle is equivalent to one opening and closing of an overhead door 2. By tracking the number of door cycles and thus predict the life cycle of the spring, the torsion spring can be replaced prior to it breaking or snapping, decreasing the possibility of injuring people and property.

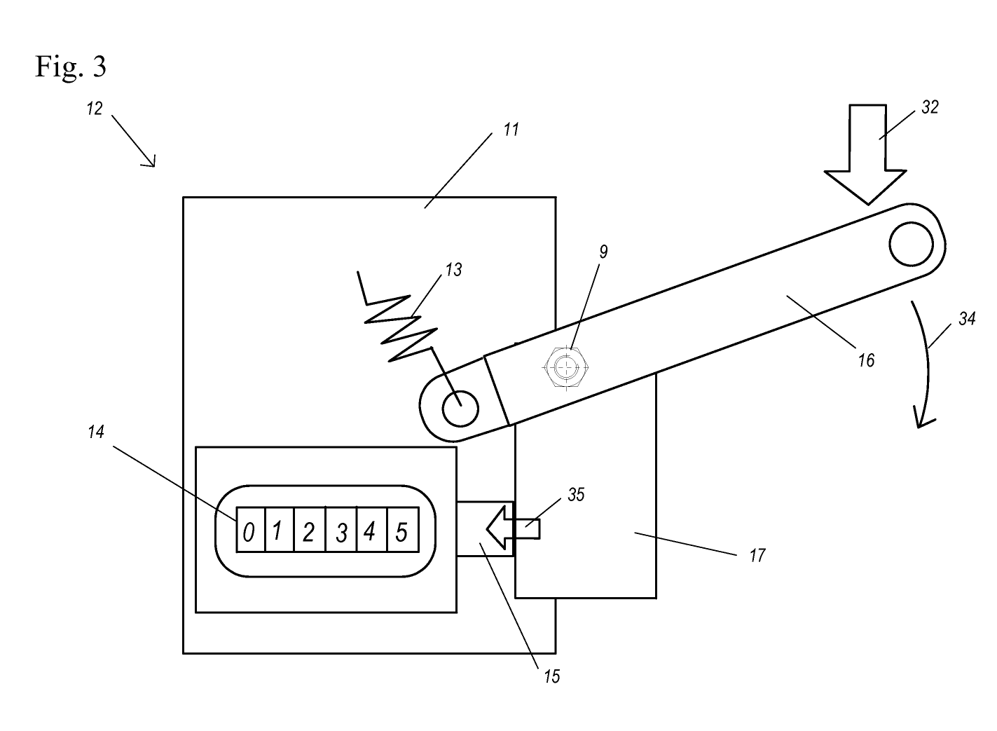

Referring to FIG. 3, the cycle tracker 12 includes a body or plate 11 that is mounted the outer edge 7 of a section 4 of the overhead door 2. A counter 14 is mounted to the body 11 and preferably has at least five digits visible and may be actuated to increment by a counter actuator 15. The counter 14 is preferably resettable. A trip lever 16 with an extension 17 is pivotally mounted to the body 11 by bolt 9. The trip lever 16 is preferably biased towards the counter actuator 15 by a resilient member or spring 13. Alternatively, the spring 13 may be replaced with a stop (not shown) that prevents the trip lever 16 from rotating away a specific distance away from the counter actuator 15. The trip lever 16 and extension 17 are pivotable from a position in which the counter actuator 15 is actuated to increment the counter 14 to another position which is adjacent to or resting against the counter actuator 15, but not actuating the counter actuator 15.

When a force 32 is applied on the trip lever 16, the trip lever 16 and the extension 17 pivot in the direction of arrow 34, extending spring 13, and actuating the counter actuator 15 (see force arrow 35) to increment the counter. The spring force of spring 13 returns the trip lever 16 and the extension 17 to a position in which the counter actuator 15 is not actuated.

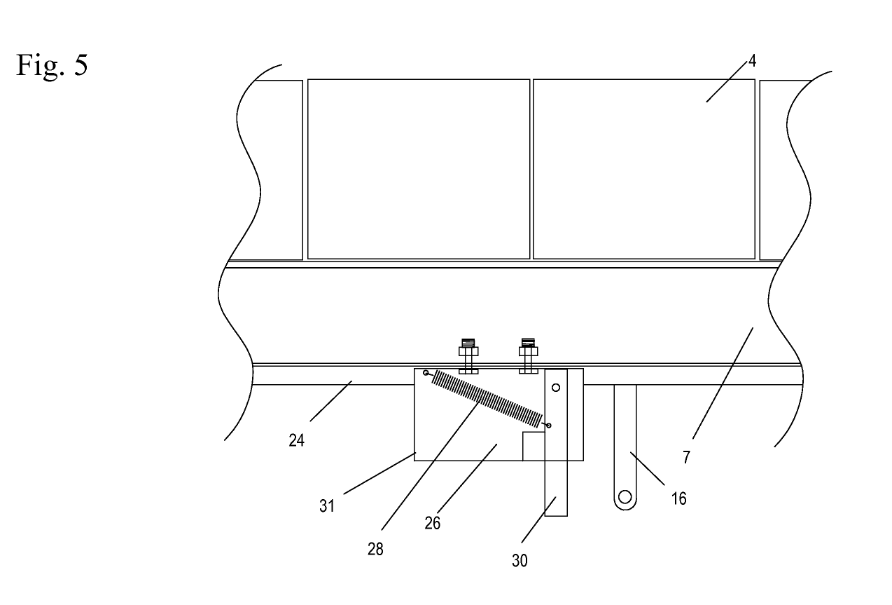

FIG. 5 shows a plate assembly 31 mounted to the horizontal track 24. The plate assembly 31 includes a plate 26 in which a plate arm 30 is biased by a spring or resilient member 28. The biased plate arm 30 provides the force 32 on the trip lever 16 when the overhead door 2 is raised or moved to an open position.

Above the overhead door is mounted a torsion spring counterbalance system. The torsion spring counter balance system includes a torsion spring 22 on a torsion shaft 20 mounted over the overhead door with a winding cone 19 on one end and a stationary cone (not shown) at the other end. At the ends of the torsion shaft 20 are cable drums 18. Counterbalance cables 23 run from the vertical tracks at the bottom corners of the door to the cable drums 18.

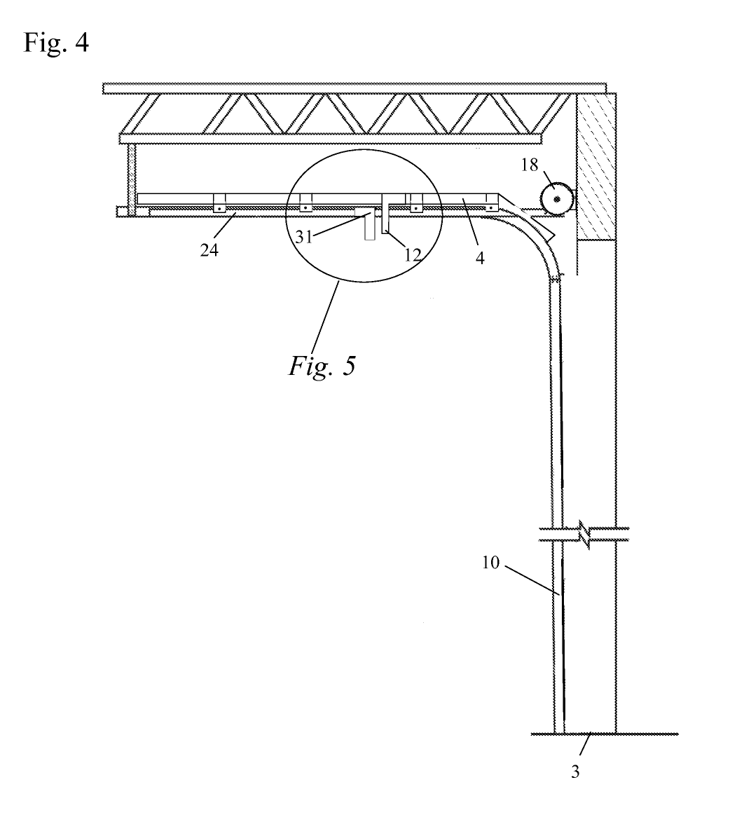

When the overhead door 2 is raised to an open position as shown in FIG. 4, the torsion spring 22 unwinds and the stored tension lifts the sections 4 of the overhead door 2 and slide on the vertical track 10 and transitions onto the horizontal track 24 by turning the shaft 20, thus turning the cable drums 18, wrapping the cables 23 around the cable drums 18. As the overhead door 2 is moving onto the horizontal track 24, the trip lever 16 comes into contact with the biased plate arm 30 of the plate assembly 31 and the biased plate arm 30 provides a force 32 on the trip lever 16, causing the trip lever 16 and extension 17 to pivot, depressing (see force arrow 35) the counter actuator 15, incrementing the counter 14 and thus counting the door lift.

When the overhead door 2 is lowered to a closed position in which an edge of one of the sections 4 is in contact with the ground 3 and the sections 4 of the overhead door 2 are on the vertical track 10, the cables 18 unwrap from the drums 18 and the torsion spring 22 is rewound to full tension.

The plate assembly 31 is preferably placed on the horizontal track 24 of the overhead door 2 to track the opening of the overhead door 2 with the cycle tracker 12, such that the number of door cycles can be used to predict the life cycle of the spring, however, one skilled in the art could also place the plate assembly 31 at the bottom of the vertical track 10 to track the closing of the overhead door using the plate assembly 31 and cycle tracker 12.

The spring force of spring or resilient member 28 biasing the plate arm 30 is preferably greater than the spring force of the spring or resilient member 13 biasing the trip lever 16.

The cycle tracker 12 is preferably attached to a section 4 of the overhead door at eye level of a user.

While a push button counter is described, other types of counters that may be actuated by trip lever may also be used.

While the cycle tracker 12 and plate assembly 31 were described and shown in reference to an overhead door 2 with a torsion spring counterbalance system, one skilled in the art could be expected to apply the cycle tracker to an overhead door with extension springs.

While the overhead door was shown as being comprised of segments, the door may also be of the type that lifts in one piece.

Accordingly, it is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A door cycle tracker for a door mounted on a track having at least one spring, the door having at least an open position and a closed position comprising:
a counter mounted to the door having an actuator for incrementing the counter;
a trip lever pivotally mounted adjacent to the counter and moveable to a position in which the trip lever actuates the counter actuator;
a plate assembly mounted adjacent to the track in a location such that when the door approaches a selected position, the trip lever contacts the plate assembly;
wherein when the door slides on the track and the trip lever contacts the plate assembly, the trip lever pivots, contacts the counter actuator and increments the counter.

2. The tracker of claim 1, wherein the counter is resettable.

3. The tracker of claim 1, wherein the selected position is when the door is in an open position.

4. The tracker of claim 1, wherein the trip lever is biased towards the counter actuator by a resilient member.

5. The tracker of claim 1, wherein the plate assembly comprises a plate arm biased by a resilient member.
